(19) United States
(12) Patent Application Publication
(10) Pub. No.: US 2006/0109868 A1
(43) Pub. Date: May 25, 2006

(54) Method and system for time synchronisation in a distributed communications network

(75) Inventor: Michael Schopp, Munich (DE)

Correspondence Address: STAAS & HALSEY LLP, SUITE 700, 1201 NEW YORK AVENUE, N.W., WASHINGTON, DC, 20005, US

(73) Assignee: SIEMENS AG, Munich (DE)

(21) Appl. No.: 11/259,110

(22) Filed: Oct. 27, 2005

(30) Foreign Application Priority Data
Oct. 27, 2004 (EP) 04025575

(51) Int. Cl. H04J 3/06

(52) U.S. Cl. 370/503

(57) ABSTRACT

Method, system and node for providing time synchronisation between local clocks located in nodes within a network and a central clock. The central clock and the nodes exchange messages. The messages transmitted contain a time stamp indicating the time of transmission. When messages are received, the time of reception is also determined. Based upon the calculation of the elapsed time taken by messages to be transmitted and received, a time difference can be estimated which indicates how much the clock on a node lags behind the central clock. Once this lag is known, the clock on the node can be updated. The proposed invention allows for a more precise time synchronisation to take place between nodes and a central clock without having to perform modifications on the transport circuitry of the system. The invention also allows for any changes in the network topology to be detected via any changes in the Round Trip Time, and a management centre to be notified in turn. Additionally, the invention allows for statistical information to be gathered in order to determine the quality of the synchronisation procedure.

### FIELD OF THE INVENTION

The invention is used in communications networks where time synchronisation between a central clock and local clocks located on nodes distributed throughout the network is necessary.

### SUMMARY OF THE INVENTION

Time synchronisation of distributed network nodes that are connected in a hub configuration to a global (master) clock through a shared off-the-shelf commercial switch, for example over a Gigabit (Gbit) Ethernet switch, is not precise enough, because the variability of transfer times between the involved elements is too high. This variability is caused by other traffic that is carried in the system which in turn causes delays to the time synchronisation data being transferred in a probabilistic fashion.

In order to overcome this problem alternative solutions have been implemented.

One such solution achieves precise time synchronisation by using dedicated infrastructure such as special circuits and dedicated links that are exclusively reserved for the exchange of timing data, between a global clock and distributed network nodes.

However, such a solution has a major drawback in that it is relatively expensive to implement and would mean that a higher initial investment would be necessary to build a network. In today's networking environment financial considerations do play an important role in the way networking environments are constructed.

Another solution is to modify the transport infrastructure (transport circuitry) of the system in order to reduce the variabilities of transfer times. This can be achieved for example in modifying the transport infrastructure to emulate a Time Division Multiple Access (TDMA) like operation which generates circuit-switched like connections between nodes with a constant transfer delay. Or in another example, by modifying the transport infrastructure in a way that traffic priorities can be assigned to the data being carried over the network. In this way, time synchronisation data is assigned the highest traffic priority and consequently such time synchronisation data will always be transmitted ahead of other lower priority traffic data which is pre-empted, thus ensuring a constant transfer delay.

However, no such features allowing for the modification of the transport infrastructure are available in today's cheap off-the-shelf commercially available systems, due to the fact that incorporating such features would cause the systems to be financially unattractive. Some systems do exist that have the traffic data prioritisation support feature but without the feature of pre-empting low priority traffic data, thus transfer times still remain variable.

Furthermore simple time synchronisation procedures are known in the art. In U.S. Pat. No. 5,790,805 to Bantum, a simple time synchronisation procedure for synchronising client based clocks with a central clock on a server is disclosed. In this procedure, a client connects to a server and sends a synchronisation message. The client then receives a return synchronisation message from the server and computes a round trip interval time between sending and receiving, by sampling a hardware clock located on the client. The sending and receiving of synchronisation messages continues for a predetermined number of times, until the client receives a final synchronisation message from the server which includes the current local server time. The client then calculates the average one-way trip interval and adds that value to the received current local server time in order to provide the client with a reliable estimate of the local server time. By calculating the difference between the client's own local time and the calculated local server time, a baseline constant is derived which is used to calculate the local client clock at any moment in time.

However, such a procedure is not precise as it does not take into account any delays that occur in a network when sending and receiving synchronisation messages. Furthermore, it does not take into account the fact that changes can occur in the network topology that can affect the Round Trip Time (RTT) or elapsed time. When such network topology changes occur, the disclosed procedure does not allow for the RTT to be adapted dynamically, thus causing the local client clock to be desynchronised.

In view of the drawbacks that exist in the prior art, an objective of the present invention is to identify a method, a system and a node that can provide a more precise time synchronisation in today's networking environment without having to resort to technically complex and costly modifications of the transport infrastructure of systems that are currently available.

The present invention provides a method for clock synchronisation, in a communications network, between a central clock device having a central clock and at least one node having a local clock comprising the steps of:

(a) exchanging synchronisation messages between said at least one node and said central clock device, wherein a first local time corresponding to the time of transmitting a first synchronisation message is determined at said least one node and a second local time corresponding to a time of reception of a second synchronisation message is determined at said at least one node, the second synchronisation message comprising information regarding a central clock time at said central clock device;

(b) calculating at said least one node an elapsed time between said first local time and said second local time and storing said elapsed time, and further using said elapsed time in calculating at said least one node a difference between the local clock of said least one node and said central clock;

(c) updating the local clock in said at least one node by adding said calculated difference to the current time of said local clock.

The present invention further provides a system adapted to perform a clock synchronisation procedure, in a communications network, between a central clock device having a central clock and at least one node having a local clock comprising:

clock synchronisation processors adapted to exchange synchronisation messages between said least one node and said central clock device, wherein the clock synchronisation processor on said least one node is further adapted to determine a first local time corresponding to a time of transmitting a first synchronisation message and to determine a second local time corresponding to a time of reception of a second synchronisation message, said second synchronisation message comprising information regarding a central clock time at said central clock device;

calculating means located on said least one node adapted to calculate an elapsed time between said first local time and said second local time, said calculating means are further adapted to use said elapsed time in calculating a difference between the local clock of said least one node and said central clock;

updating means located on said least one node adapted to update said local clock by adding said calculated difference to the current time of said local clock.

The present invention further provides a node having a local clock, adapted to perform a clock synchronisation procedure in a communications network comprising:

a clock synchronisation processor adapted to exchange synchronisation messages between said node and a central clock device having a central clock, wherein the clock synchronisation processor on said node is further adapted to determine a first local time corresponding to a time of transmitting a first synchronisation message and to determine a second local time corresponding to a time of reception of a second synchronisation message, said second synchronisation message comprising information regarding a central clock time at said central clock device;

calculating means adapted to calculate an elapsed time between said first local time and said second local time, said calculating means are further adapted to use said elapsed time in calculating a difference between the local clock and said central clock;

updating means adapted to update said local clock by adding said calculated difference to the current time of said local clock.

Thus the above method, system and node are advantageous as they provide great benefits in a networking environment, in allowing for distributed network nodes to maintain their local clocks synchronised with a central clock, in a precise and exact manner.

Further optional advantages can be seen in the dependent claims, where the synchronisation messages transmitted have the same length and the same data rate in order to ensure that the transmission times of the synchronisation messages are constant. Additionally, delays experienced by the synchronisation messages are detected and are used in determining whether the clock synchronisation procedure is to be performed or terminated, ensuring an efficient procedure. Furthermore, these delays can be determined either as time values corresponding to the experienced delays or as indicators indicating that a delay occurred, allowing for a versatile clock synchronisation procedure. A yet another advantage of this invention is that a comparison between the values of calculated round trip times is performed and if a variance is detected, feedback to a network management centre is provided in the form of an alarm message, allowing for troubleshooting to be performed, thus maintaining an efficient network.

### SHORT DESCRIPTION OF THE DRAWINGS

The present invention may be understood more readily, and various other aspects and features of the invention may become apparent from consideration of the following description and accompanying figures which are given by way of illustration only, and thus are not limitative of the present invention, and wherein:

FIG. 1, shows a typical distributed network comprising a central clock and nodes.

FIG. 2, shows the flow chart of the time synchronisation protocol located at a network node.

FIG. 3, shows the flow chart of the time synchronisation protocol located at a central clock.

### DETAILED DESCRIPTION OF THE INVENTION

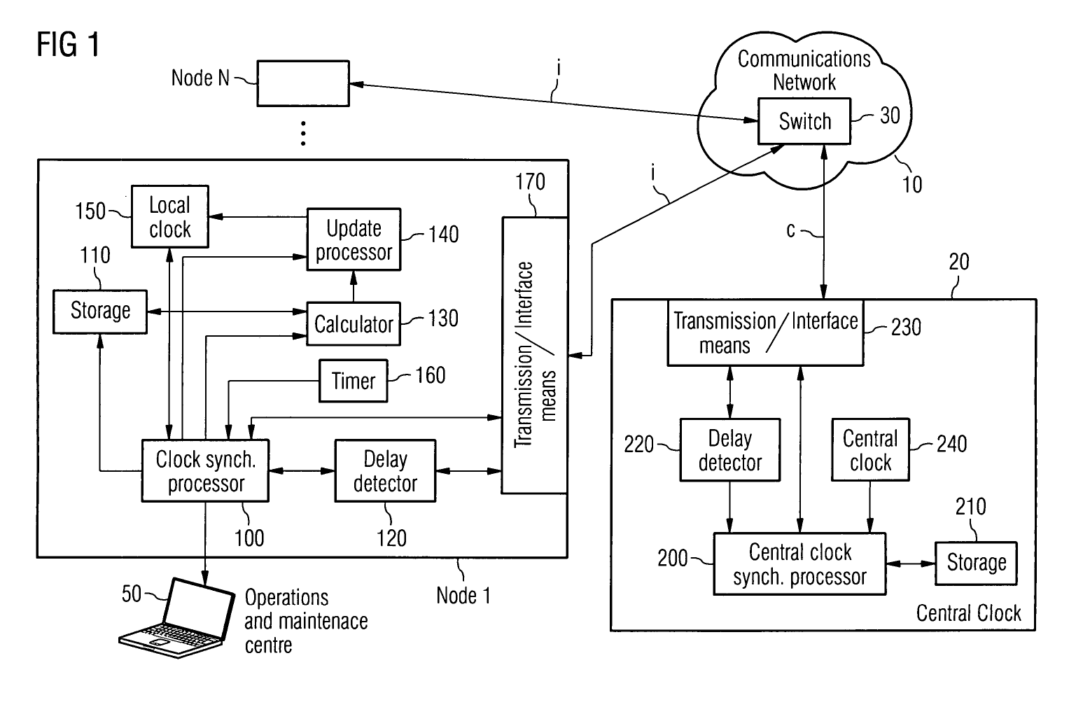

As can be seen in FIG. 1, a typical distributed network consists of N nodes, e.g, node 1, . . . node N, that are connected to a central clock 20 and to other destinations through a switch 30. The terms “global clock”, “master clock”, “central clock” are synonymous and well known in the art. Each one of the N nodes 1, . . . N has a local clock 150 that requires time synchronisation with the more precise central clock. In order for this to be achieved, each node will communicate with the central clock via the switch 30. As it can be seen from FIG. 1, the central clock is connected to the switch through a dedicated link thus ensuring that only a small amount of traffic is carried on this link.

Each node, as can be seen in FIG. 1, comprises of a clock synchronisation processor 100 which executes the procedure from the side of the node, storage means 110 for storing the different time values necessary for performing the synchronisation procedure, a delay detector 120 for detecting whether synchronisation messages transmitted during the synchronisation procedure experience delays, a calculator 130 for performing the necessary calculations in the procedure, an update processor 140 for updating the local clock with the necessary values in order to synchronise the time on the local clock with that of the central clock 20, a local clock 150, a timer 160 for generating a random time to be used when the back-off procedure is performed, and transmission means/interface 170 for transmitting and receiving synchronisation messages.

The central clock 20, also shown in FIG. 1, comprises of a central clock synchronisation processor 200 which executes the procedure from the side of the central clock, storage means 210 for storing the different time values necessary for performing the synchronisation procedure, a delay detector 220 for detecting whether synchronisation messages transmitted during the synchronisation procedure experience delays, transmission means/interface 230 for transmitting and receiving synchronisation messages and a central clock 240 for providing a central time to each node.

In general, it can be assumed that the communication infrastructure is priority based and functions without any pre-emption of transmissions already in progress. Therefore the transfer time of a message over a link can be decomposed into the following components: W+T+D.

Where W is the waiting time before the transmission of the message begins.

Where T is the transmission time of the message, and is proportional to the length of the message and the transmission rate of the link.

Where D is the transmission delay, and is proportional to the length of the link and to the speed of the electromagnetic waves on the link.

W can be further decomposed into the following components: Waiting time until the end of the transmission of the message that is currently being transmitted on the link+Transmission time of all messages of the same or higher priority that arrived at an earlier time+Transmission time of all messages of higher priority that arrive during the waiting time W.

When a node sends a message to the central clock 20 and the central clock 20 replies with a message containing the current time GT at the central clock 20, the Round Trip Time RTT of the message exchange can be calculated in the following equation as follows:
RTT=Wᵢ^{up}+W_{C}^{down}+W_{C}^{up}+Wᵢ^{down}+Tᵢ^{up}+T_{C}^{down}+T_{C}^{up}+Tᵢ^{down}+Dᵢ^{up}+D_{C}^{down}+D_{C}^{up}+Dᵢ^{down}+S_{i-to-C}+S_{C-to-i}
Where the indices of W, T and D indicate the corresponding link in FIG. 1 (i=the link from the node to the switch 30; c=the link from the central clock to the switch 30; up=direction from node or clock towards the switch; down=direction from switch to node or clock).
The terms S_{i-to-C} and S_{C-to-i} give the switching delays within the switch.

Any terms in the equation that can be considered to be constant do not have a negative impact on the preciseness of the time synchronisation. Following this it can be assumed that the sum of all D is always constant, as are the terms S_{i-to-C} and S_{C-to-i}.

The invention also ensures that the sum of all T in the equation is constant and that each direction contributes half of the sum by defining that all messages sent from a node to the clock and all messages sent from the clock to a node have the same equal length, and also by ensuring that the transmission rate of the links is the same in both directions (though it may be different on different links). The message can be defined to have a maximum length Lmax, depending now on the coding used, if the message after coding is shorter in length to Lmax then filling bits are added. An alternative to this is to create a dummy parameter which is added to all messages that are smaller to Lmax. The same transmission rate is ensured by selecting symmetric transmission technologies.

The inventive aspect of the invention exploits the fact that by monitoring a link, the monitoring instance such as a node or the central clock, can identify transmissions which did not experience any waiting time W before transmission. Therefore the following rule can be applied: Any transmission that is preceded by an idle state of the link did not experience any waiting time W.

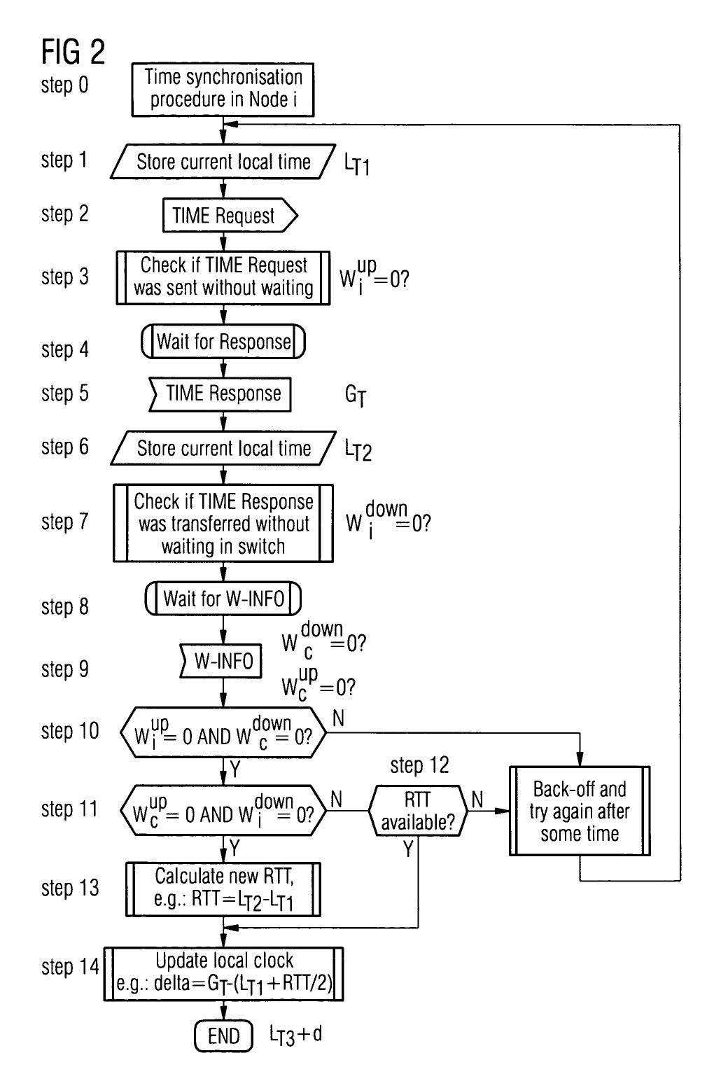

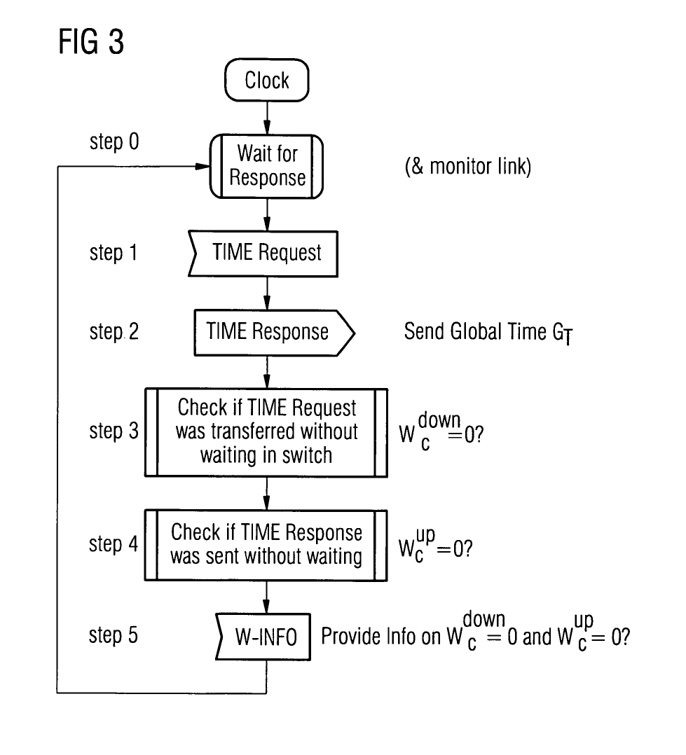

Each node (node 1, . . . node N) in the network and the central clock 20 both monitor their respective links in both directions and identify transmissions that did not experience any waiting time before being transmitted on the particular link they are monitoring. In the proposed invention, the central clock 20 will transmit to a node an additional synchronisation message W-INFO that contains information relating to the time-delay that the node's time synchronisation request and the reply back to it experienced at the central clock 20. This is done for each individual node. FIGS. 2 and 3, show the corresponding algorithm of the time synchronisation protocol at a node and at the central clock. The procedure triggering the launching of the protocol is triggered by each node at regular intervals in order to keep their respective local clock synchronised with the central clock. In this way, changes in the network topology that affect the RTT can be detected and the RTT updated. Additionally, in the case of the RTT being updated, which would indicate that earlier synchronisations may have been wrong due to network configuration changes, a notification message such as an alarm, is triggered and sent to an operations and maintenance centre 50 to notify that a change in the network configuration has occurred.

Furthermore, in regularly performing the time synchronisation statistical information can be gathered such as the variance of the RTT, which can be used to determine the network load and the performance of the synchronisation procedure.

As stated above, each node monitors its respective link for transmissions that did not experience a delay in the following way.

(1) In the ideal case Wᵢ^{up}, W_{C}^{down}, W_{C}^{up}, Wᵢ^{down} are all zero. This permits the RTT of a quasi unloaded system to be measured and to adjust the local clock according to this RTT and to the time information received from the central clock. For the purposes of the invention Wᵢ^{up}, W_{C}^{down}, W_{C}^{up}, Wᵢ^{down} can either be time values corresponding to the experienced delays or indicators indicating that a delay occurred.

(2) In the second best case Wᵢ^{up}, W_{C}^{down} are both zero. This does not permit the RTT of a quasi unloaded system to be measured. However, if the RTT of a quasi unloaded system is already known from at least one previous measurement, as can be in the case when the start-up of the system takes place or in the case of (1) having occurred, the one way delay between a particular node (node 1, . . . node N) and the central clock can be estimated as RTT/2 and the local clock can be corrected according to the difference between the local time when sending the time request and the value of the global time that is reported back from the central clock minus RTT/2.

(3) If neither (1) nor (2) apply, the node will then use a back-off algorithm to determine a period of time that shall expire before the procedure is triggered again. The back-off time should be random and should increase each time W_{C}^{down} or W_{C}^{up} are not zero in order to avoid potential collisions of time synchronisation messages from different nodes on the link between the switch and the central clock. For the back-off algorithm, any type of back-off algorithm can be used, like for example the exponential back-off algorithm used in the Transport Control Protocol (TCP). The clock synchronisation processor 100 will use the timer 160 to generate the random time value used when performing the back-off.

Additional measures can be taken to control the probability of (1) and (2) occurring. These are:

Time intervals between the triggering of the time synchronisation procedures in the nodes, should be long enough so as to create only a very light load on the link between the switch and the central clock, thus avoiding time synchronisation messages of different nodes interfering with each other.

The triggering of the synchronisation procedure in the nodes is asynchronous thus avoiding that time synchronisation messages of different nodes interfering with each other and causing delays. This is assured by introducing randomness into the time intervals between two triggerings of the procedure.

A node (node 1, . . . node N) can ensure that Wᵢ^{up}, is always zero by local measures. This can be affected by the node sending a message to the local interface a short time in advance of the time synchronisation procedure being triggered to go idle and to wait for the procedure to send a time synchronisation message. This measure increases the probability of (2) occurring.

A node (node 1, . . . node N) can increase the probability of Wᵢ^{up} and Wᵢ^{down} being equal to zero by initiating the time synchronisation procedure when the amount of traffic in the system is low. This can occur when the link to the switch is currently idle or when the node does not expect any traffic from other sources. This measure increases the probability of (1) occurring.

A node (node 1, . . . node N) can initiate the time synchronisation procedure at system start-up when no traffic is in the system in order to obtain a good estimate of RTT. This measure makes the system operational even when the probability of (1) occurring is relatively low in a regular system operation.

Based on the above description and with the aid of FIGS. 2 and 3, there follows a step by step analysis of the proposed procedure:

In step 0 of FIG. 2, the time synchronisation procedure is triggered, this will ensure that in step 1 the time synchronisation procedure will check the local clock time and store the current local time LT1 value in memory. In step 2 a node will send a time synchronisation request message to the central clock. In step 3, the node will check whether the time synchronisation request message was sent without any delay at the local interface (Wᵢ^{up}=0?). In step 4, the procedure will cause the node to wait for a response to the message sent in step 2. In step 5, the node will receive a time response reply message from the central clock which will contain the global time GT value from the central clock and will then stored it. In step 6, the node will further store the local time value LT2 at the instant of reception of the time response message sent by the central clock (step 5). In step 7, the procedure will cause the node to check if the time response reply message was transferred without any delay in the switch (Wᵢ^{down}=0?). In step 8, the procedure will cause the node to wait for the central clock to send information W-INFO regarding any delays caused on the link between the central clock and the switch W_{C}^{up}, W_{C}^{down}. In step 9, the node receives this information and stores it in memory. Once the information has been received and stored, the procedure will perform a check, in step 10, to verify whether Wᵢ^{up} and W_{C}^{down} are both equal to zero. If the result is negative N a back-off timer mechanism is triggered and the procedure returns to step 1. If the result is positive Y the procedure will go onto step 11, where another check is performed to verify whether W_{C}^{up} and Wᵢ^{down} are both equal to zero. If the result is positive Y the procedure will go onto step 13 where the new RTT is calculated LT2−LT1 and the value stored in memory. In step 14 the procedure will then update the local clock modifying the local time based on the result of the calculation G_{T}−(LT1+RTT/2). Once the local clock has been updated the procedure will end, and it will return to step 0 until it is triggered to restart. If in step 11, the result is negative N the procedure will go onto step 12, where a check is performed to verify whether a RTT value is available. If such a value is not available then a back-off timer mechanism is triggered and the procedure returns to step 1. If such a value is available then the procedure will go onto step 14 in order to update the local clock.

In step 0 of FIG. 3, the central clock monitors its link to the switch and waits for a time synchronisation request message to be received. In step 1, a time synchronisation request message is received. This will cause the procedure to go onto step 2, whereby a time response reply message from the central clock which will contain the global time GT value from the central clock will be sent back to the node that requested it. The length of the time response reply message is equal to the length of the time synchronisation request message received in step 1. In step 3, the central clock will check whether the time synchronisation request message suffered any delay in the switch (W_{C}^{down}=0?). In step 4, the central clock will further check if the time response message suffered any delay at the local central clock interface (W_{C}^{up}=0?). In step 5, the central clock will transmit this information W_{C}^{down}, W_{C}^{up} to the node that requested the time synchronisation. The procedure will then return to step 0.

Although the invention has been described in terms of a preferred embodiment described herein, those skilled in the art will appreciate other embodiments and modifications which can be made without departing from the scope of the teachings of the invention. All such modifications are intended to be included within the scope of the claims appended hereto.

1. A method for clock synchronisation, in a communications network (10), between a central clock device (20) having a central clock (240) and at least one node (node 1, . . . , node N) having a local clock (150) comprising the steps of:
(a) exchanging synchronisation messages between said at least one node (node 1, . . . , node N) and said central clock device (20), wherein a first local time (LT1) corresponding to the time of transmitting a first synchronisation message is determined at said least one node (node 1, . . . , node N) and a second local time (LT2) corresponding to a time of reception of a second synchronisation message is determined at said at least one node (node 1, . . . , node N), the second synchronisation message comprising information regarding a central clock time (G_{T}) at said central clock device (20);
(b) calculating at said least one node (node 1, . . . , node N) an elapsed time between said first local time (LT1) and said second local time (LT2) and further using said elapsed time in calculating at said least one node (node 1, . . . , node N) a difference between the local clock (150) of said least one node (node 1, . . . , node N) and said central clock (240);
(c) updating the local clock (150) in said at least one node (node 1, . . . , node N) by adding said calculated difference to the current time of said local clock (150).

2. A method according to claim 1, wherein the synchronisation messages transmitted have an identical length and an identical data rate.

3. A method according to claim 1, further comprising the step 35 of determining at said least one node (node 1, . . . , node N) when said synchronisation messages experience delays.

4. A method according to claim 3, wherein said at least one node (node 1, . . . , node N), upon determining a delay in the transmission of a first synchronisation message to the said central clock device (20), determines a first delay (Wi″), and upon determining a delay in the transmission of the second synchronisation message containing said central clock time (G_{T}), determines a second delay _{(wi}d^{o}w n)

5. A method according to claim 3, further comprising the step of said central clock device (20), upon determining a delay in the transmission of a first synchronisation message from said at least one node (node 1, . . . , node N), determines a third delay (Wc^{down}), and upon determining a delay in the transmission of said second synchronisation message containing said information regarding a central clock time (G_{T}), determines a fourth delay (Wc″^{p}) and transmits said third and fourth delays (Wc^{do}″ⁿ, We′″) to said at least one node (node 1, . . . , node N) via a further synchronisation message (W-INFO).

6. A method according to claim 4, wherein said at least one node (node 1, . . . , node N) further determines whether said determined delays (Wi″^{p}, Wi^{do}′″ⁿ, Wc^{do}″, Wc^{UP}) are equal to zero and upon determining that said determined delays (Wi″p, _{wi}d^{o}wn, Wcd^{o}Wn, We″^{p}) are equal to zero, proceeding to step (c).

7. A method according to claim 6, wherein said at least one node (node 1, . . . , node N) upon determining that said first and third delays (Wi″^{p}, Wc^{do}″) are not equal to zero, terminates said clock synchronisation and restarts said clock synchronisation at a later time using a random generated back-off timer (160) to generate said later time.

8. A method according to claim 6, wherein said at least one node (node 1, . . . , node N) upon determining that said first and third delays (Wi″p, ^{Wcdown)} are equal to zero and that said second and fourth delays (Wi^{do}′″ⁿ, We″) are not equal to zero, verifies whether said elapsed time exists from a previous clock synchronisation.

9. A method according to claim 8, wherein said at least one node (node 1, . . . , node N) upon verifying that said elapsed time exists uses this value in said calculation of said difference in step (c), and upon verifying that said elapsed time does not exist terminates said clock synchronisation and restarts said clock synchronisation at a later time using a random generated back-off timer (160) to generate said later time.

10. A method according to claim 1, wherein step (c) further comprises a step of comparing said calculated elapsed time to a previously calculated elapsed time and upon detecting a variance between said two elapsed times, transmitting an alarm to a network management centre (50).

11. A system adapted to perform a clock synchronisation procedure, in a communications network (10), between a central clock device (20) having a central clock (240) and at least one node (node 1, . . . , node N) having a local clock (150) comprising:
clock synchronisation processors (100, 200) adapted to exchange synchronisation messages between said least one node (node 1, . . . , node N) and said central clock device (20), wherein the clock synchronisation processor (100) on said least one node (node 1, . . . , node N) is further adapted to determine a first local time (LT1) corresponding to a time of transmitting a first synchronisation message and to determine a second local time (LT2) corresponding to a time of reception of a second synchronisation message, said second synchronisation message comprising information regarding a central clock time (G_{T}) at said central clock device (20);
calculating means (130) located on said least one node (node 1, . . . , node N) adapted to calculate an elapsed time between said first local time (LT1) and said second local time (LT2), and upon performing said calculation adapted to store said elapsed time in storing means (110), said calculating means (130) are further adapted to use said stored elapsed time in calculating a difference between the local clock (150) of said least one node ((node 1, . . . , node N) and said central clock (240);
updating means (140) located on said least one node (node 1, . . . , node N) adapted to update said local clock (150) by adding said calculated difference to the current time of said local clock (150).

12. A system according to claim 11, further comprising detection means (120) located on said least one node (node 1, . . . , node N) adapted to determine when said synchronisation messages experience delays.

13. A system according to claim 12, wherein said detection means (120) are further adapted to determine a first delay (Wi′^{P}) upon determining a delay in the transmission of a first synchronisation message to said central clock device (20), and to determine a second delay (Wi^{down}) upon determining a delay in the transmission of the second synchronisation message containing information regarding the central clock time (G_{T}).

14. A system according to claim 12, wherein said detection means (220) located on said central clock device (20) are adapted to determine a third delay (Wc^{down}) upon determining a delay in the transmission of the first synchronisation message from said at least one node (node 1, . . . , node N), and to determine a fourth delay (Wc″^{P}) upon determining a delay in the transmission of said synchronisation message containing information regarding said central clock time (G_{T}) and wherein transmission means (230) located on said central clock device (20) are adapted to transmit said third and fourth delays (Wc^{down}, Weⁱ′) to said at least one node (node 1, . . . , node N) via a further synchronisation message (W-INFO).

15. A system according to claim 13, wherein said detection means (120) located at said least one node (node 1, . . . , node N) are further adapted to determine whether said determined delays (Wi″p, _{wi}d∘wn, WCdown, Wc″^{D}) are equal to zero, and upon detecting that said delays are equal to zero are further adapted to notify a clock synchronisation processor (100) located at said least one node (node 1, . . . , node N), said clock synchronisation processor (100) adapted to notify an update processor (140) to update said local clock (150).

16. Anode (node 1, . . . node N) having a local clock (150), adapted to perform a clock synchronisation procedure in a 20 communications network (10) comprising:
a clock synchronisation processor (100) adapted to exchange synchronisation messages between said node (node 1, . . . node N) and a central clock device (20) having a central clock (240), wherein the clock synchronisation processor (100) on said node (node 1, . . . node N) is further adapted to determine a first local time (LT1) corresponding to a time of transmitting a first synchronisation message and to determine a second local time (LT2) corresponding to a time of reception of a second synchronisation message from said central clock device (20), said second synchronisation message comprising information regarding a central clock time (G_{T}) at said central clock device (20);
calculating means (130) adapted to calculate an elapsed time between said first local time (LT1) and said second local time (LT2), and upon performing said calculation adapted to store said elapsed time in storing means (110), said calculating means (130) are further adapted to use said stored elapsed time in calculating a difference between the local clock (150) and said central clock (240);
updating means (140) adapted to update said local clock (150) by adding said calculated difference to the current time of said local clock (150).

17. A method according to claim 4, further comprising the step of said central clock device, upon determining a delay in the transmission of a first synchronisation message from said at least one node, determines a third delay, and upon determining a delay in the transmission of said second synchronisation message containing said information regarding a central clock time, determines a fourth delay and transmits said third and fourth delays to said at least one node via a further synchronisation message.

18. A method according to claim 5, wherein said at least one node further determines whether said determined delays are equal to zero and upon determining that said determined delays are equal to zero, proceeding to step (c).

19. A method according to claim 17, wherein said at least one node further determines whether said determined delays are equal to zero and upon determining that said determined delays are equal to zero, proceeding to step (c).

20. A system according to claim 13, wherein said detection means located on said central clock device are adapted to determine a third delay upon determining a delay in the transmission of the first synchronisation message from said at least one node, and to determine a fourth delay upon determining a delay in the transmission of said synchronisation message containing information regarding said central clock time and wherein transmission means located on said central clock device are adapted to transmit said third and fourth delays to said at least one node via a further synchronisation message.
